(19) United States
(12) Patent Application Publication
(10) Pub. No.: US 2025/0262863 A1
(43) Pub. Date: Aug. 21, 2025

(54) MAINTENANCE DEVICE AND INKJET RECORDING APPARATUS

(71) Applicant: KYOCERA Document Solutions Inc., Osaka (JP)

(72) Inventors: Takashi MORITA, Osaka-shi (JP); Tatsuhiko YOSHII, Osaka-shi (JP)

(73) Assignee: KYOCERA Document Solutions Inc., Osaka (JP)

(21) Appl. No.: 19/051,141

(22) Filed: Feb. 11, 2025

(30) Foreign Application Priority Data
Feb. 21, 2024 (JP) 2024-024269

(51) Int. Cl. B41J 2/165; B41J 2/17

(52) U.S. Cl. CPC B41J 2/16552; B41J 2/1721; B41J 2002/16558; B41J 2002/16594

(57) ABSTRACT

A maintenance device includes a frame body, a pressing roller, a counter roller, an endless belt-like member, and a driving part. The frame body stores a cleaning liquid. The pressing roller is exposed upward from the frame body and pressed against a nozzle surface of an inkjet head. The counter roller is provided below the pressing roller and immersed in the cleaning liquid. The endless belt-like member is wound around the pressing roller and the counter roller. The driving part circulates the belt-like member.

### INCORPORATION BY REFERENCE

This application is based on and claims the benefit of priority from Japanese patent application No. 2024-024269 filed on Feb. 21, 2024, which is incorporated by reference in its entirety.

### BACKGROUND

The present disclosure relates to a maintenance device and an inkjet recording apparatus.

In the inkjet recording apparatus, there is a possibility that ink remains on or sticks to a nozzle surface of an inkjet head, causing ejection failure. Therefore, a technique for cleaning the nozzle surface has been studied. For example, there is a configuration in which a wiper scrapes a cleaning liquid from a cleaning liquid supply port adjacent to the nozzle surface, and the wiper holding the cleaning liquid slides along the nozzle surface. Further, there is a configuration including a container containing a cleaning liquid and a blade which moves around in a flow pass immersed in the cleaning liquid and wipes the nozzle surface.

However, in the above configuration, since the wiper and the blade each has a low capacity to hold the cleaning liquid, an amount of the cleaning liquid supplied to the nozzle surface is insufficient. As a configuration capable of increasing an amount of the cleaning liquid supplied, it is conceivable that a belt-shaped member holding the cleaning liquid is fed in a roll-to-roll manner and pressed against the nozzle surface. However, in the roll-to-roll system, since the belt-shaped member is disposable, there are problems such as a high running cost, trouble for replacing the belt-shaped member, and an increase in waste.

### SUMMARY

A maintenance device according to the present disclosure includes a frame body, a pressing roller, a counter roller, an endless belt-like member, and a driving part. The frame body stores a cleaning liquid. The pressing roller is exposed upward from the frame body and pressed against a nozzle surface of an inkjet head. The counter roller is provided below the pressing roller and immersed in the cleaning liquid. The endless belt-like member is wound around the pressing roller and the counter roller. The driving part circulates the belt-like member.

An inkjet recording apparatus according to the present disclosure includes the inkjet head, and the maintenance device.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a perspective view showing an external appearance of an inkjet recording apparatus according to one embodiment of the present disclosure.

FIG. 2 is a side view schematically showing an internal structure of the inkjet recording apparatus according to the embodiment of the present disclosure.

FIG. 3 is a perspective view schematically showing the internal structure of the inkjet recording apparatus according to the embodiment of the present disclosure.

FIG. 4 is a perspective view showing an inkjet head according to the embodiment of the present disclosure.

FIG. 5 is a perspective view showing the inkjet head according to the embodiment of the present disclosure.

FIG. 6 is a right side view showing the inkjet head according to the embodiment of the present disclosure.

FIG. 7 is a bottom view showing the inkjet head according to the embodiment of the present disclosure.

FIG. 8 is a rear view showing the inkjet head according to the embodiment of the present disclosure.

FIG. 9 is a plan view showing a cleaning liquid supply unit and the inkjet head according to the embodiment of the present disclosure.

FIG. 10 is a right side view showing the cleaning liquid supply unit and the inkjet head according to the embodiment of the present disclosure.

FIG. 11 is a rear view showing the cleaning liquid supply unit and the inkjet head according to the embodiment of the present disclosure.

FIG. 12 is a cross-sectional view showing the cleaning liquid supply unit and the inkjet head according to the embodiment of the present disclosure.

FIG. 13 is a cross-sectional view showing the cleaning liquid supply unit and the inkjet head according to the embodiment of the present disclosure.

FIG. 14 is a cross-sectional view showing the cleaning liquid supply unit and the inkjet head according to the embodiment of the present disclosure.

FIG. 15 is a cross-sectional view showing a modified example of the embodiment of the present disclosure, to which the cap is attached.

### DETAILED DESCRIPTION

Hereinafter, with reference to the attached drawings, an inkjet recording apparatus 1 according to one embodiment of the present disclosure will be described below.

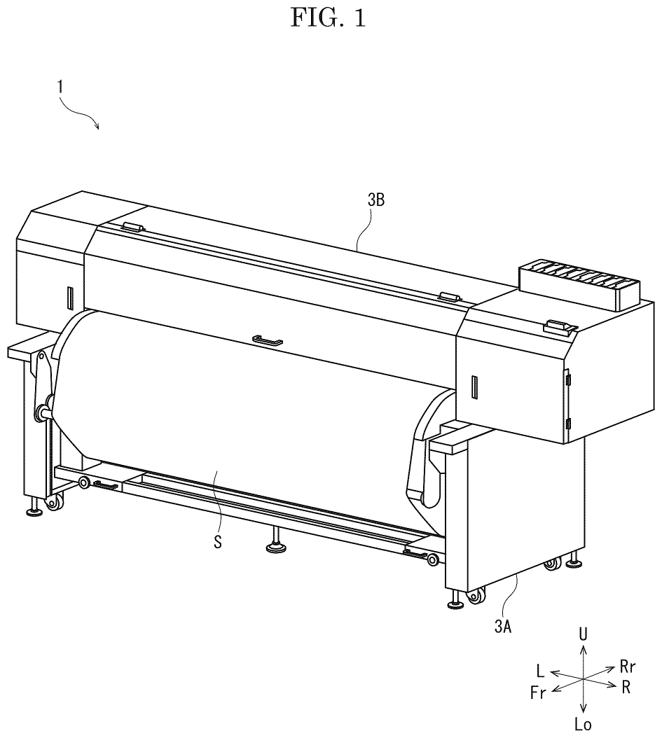

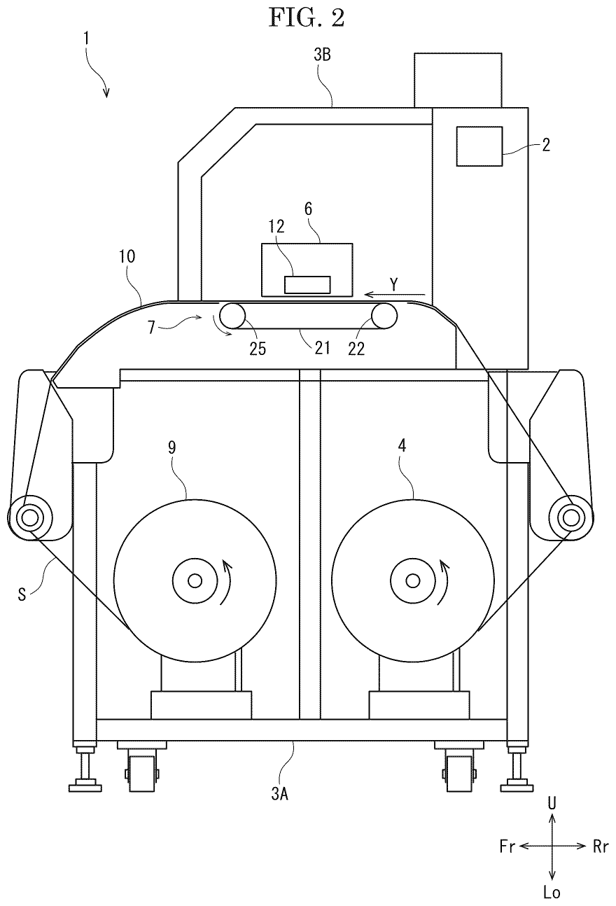

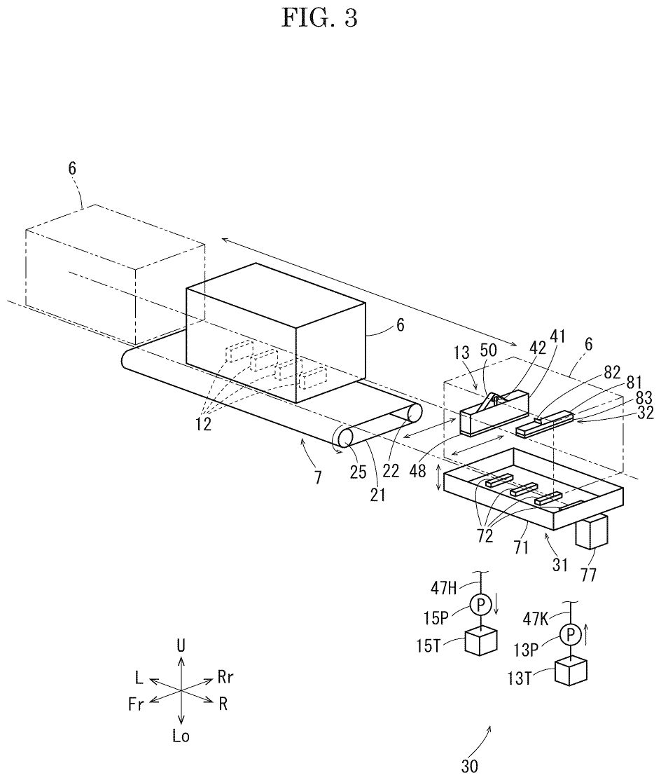

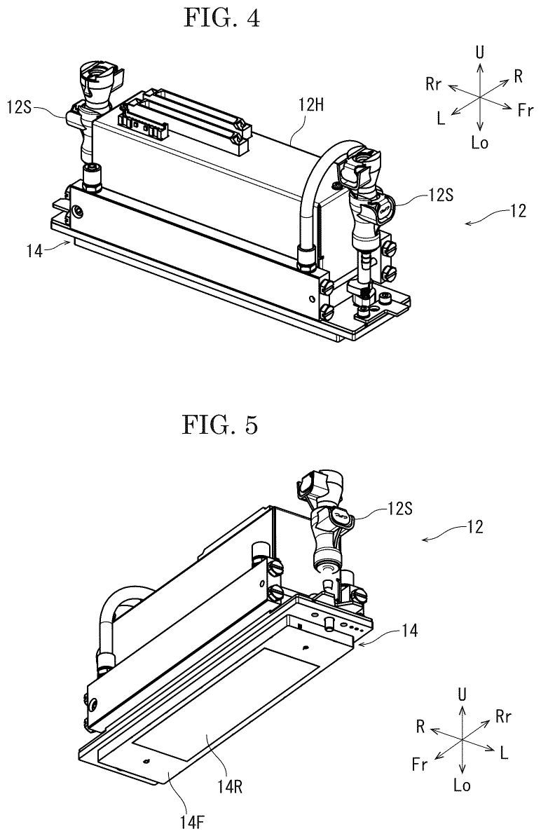

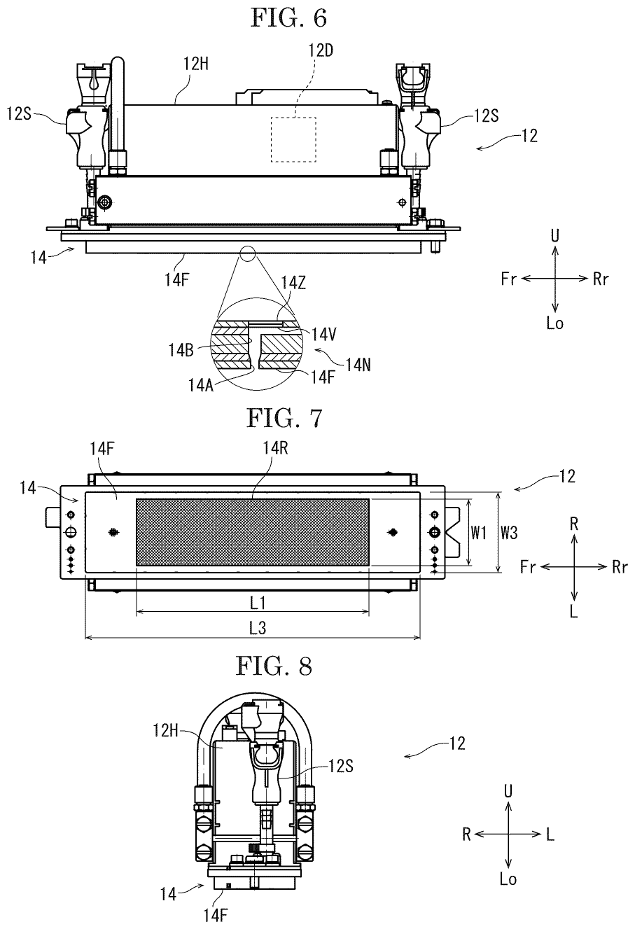

FIG. 1 is a perspective view showing an external appearance of the inkjet recording apparatus 1. FIG. 2 is a side view schematically showing an internal structure of the inkjet recording apparatus 1. FIG. 3 is a perspective view schematically showing the internal structure of the inkjet recording apparatus 1. FIG. 4 and FIG. 5 are perspective views showing an inkjet head 12. FIG. 6 is a right side view showing the inkjet head 12. FIG. 7 is a bottom view showing the inkjet head 12. FIG. 8 is a rear view showing the inkjet head 12. Hereinafter, the left side of the paper plan on which FIG. 2 is drawn is defined as the front side of the inkjet recording apparatus 1, and the right-and-left directions will be described with reference to the direction in which the inkjet recording apparatus 1 is viewed from the front side. In each figure, U, Lo, L, R, Fr, and Rr indicate the upper, lower, left, right, front, and rear, respectively.

The inkjet recording apparatus 1 (see FIG. 1 and FIG. 2) includes a lower housing 3A and an upper housing 3B provided above the lower housing 3A. Inside the lower housing 3A, a feed roll 4, a rewind roll 9 provided in front of the feed roll 4, a conveying unit 7 provided above the feed roll 4 and the rewind roll 9, and a conveyance path 10 extending from the feed roll 4 to the rewind roll 9 via the conveying unit 7 are provided. One end of a sheet S is wound around the feed roll 4, and the other end of the sheet S is wound around the rewind roll 9. The sheet S is made of paper, resin film, cloth or the like. The conveying unit 7 includes a driving roller 25, a driven roller 22 arranged on the rear side of the driving roller 25 parallel to the driving roller 25, and an endless belt 21 wound around the driving roller 25 and the driven roller 22.

Inside the upper housing 3B, an image forming unit 6 and a maintenance device 30 are provided. The image forming unit 6 includes a plurality of (in this embodiment, four) inkjet heads 12 facing the conveying unit 7. The image forming unit 6 ejects ink to the sheet S on the conveying unit 7 while reciprocating in the left-and-right directions by a driving device (not shown). The maintenance device 30 will be described later.

The inkjet head 12 (see FIG. 6) includes a rectangular parallelepiped housing 12H whose longitudinal direction is along the front-and-rear direction, a nozzle plate 14 whose longitudinal direction is along the front-and-rear direction and provided at the bottom of the housing 12H, and a socket 12S to which a pipe for supplying the ink is connected. The nozzle plate 14 has a large number of nozzles 14N arranged in the front-and-rear direction. The nozzle 14N has a branch flow pass 14B branched from the downstream side of the socket 12S and a plurality of ejection ports 14A provided on a nozzle surface 14F which is a lower surface of the nozzle plate 14. The ejection ports 14A are provided in a rectangular region (referred to as an ejectable region 14R) of the nozzle surface 14F excluding the front and rear end portions and the left and right end portions. A diaphragm 14V also serves as a part of the inner wall of the branch flow pass 14B. The diaphragm 14V is provided with a pressurizing element 14Z. As the pressurizing element 14Z, a piezoelectric element, an electrostatic actuator, a heater, and the like are used. A driving circuit 12D for driving the pressurizing element 14Z is connected to the pressurizing element 14Z.

The control part 2 (see FIG. 2) includes an arithmetic part and a storage part (not shown). The arithmetic part is, for example, a CPU (Central Processing Unit). The storage part includes a storage medium such as ROM (Read Only Memory), RAM (Random Access Memory), and EEPROM (Electrically Erasable Programmable Read Only Memory). The arithmetic part reads and executes control program stored in the storage part to perform various processes. The control part 2 may be implemented by an integrated circuit that does not use software.

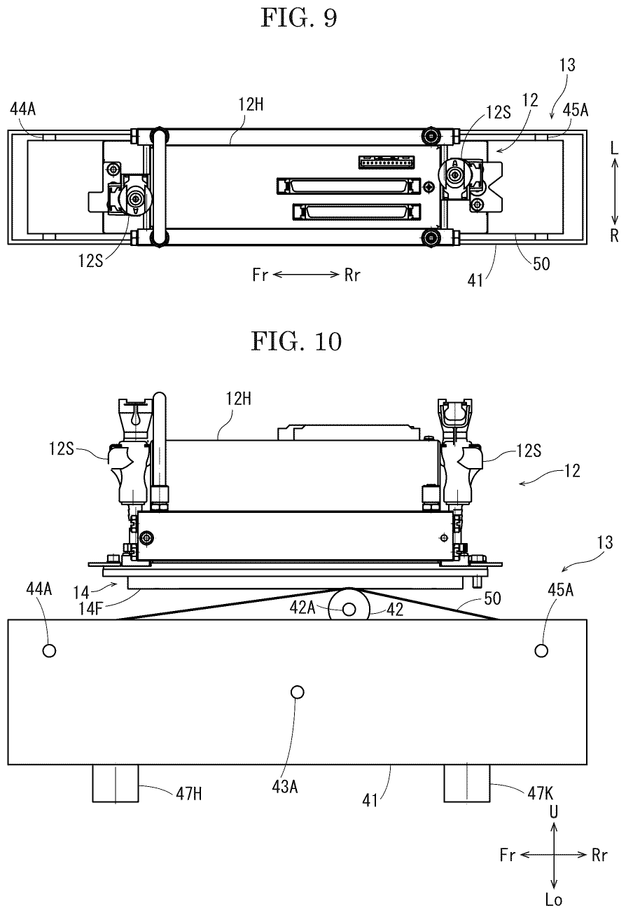

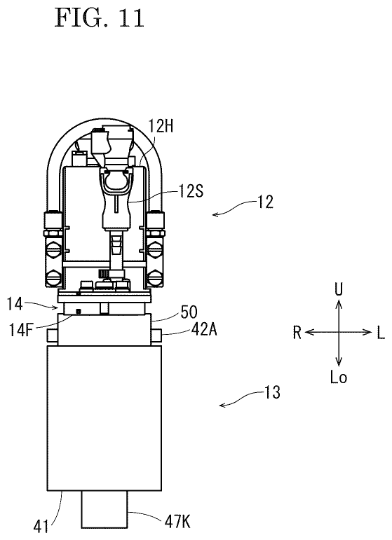

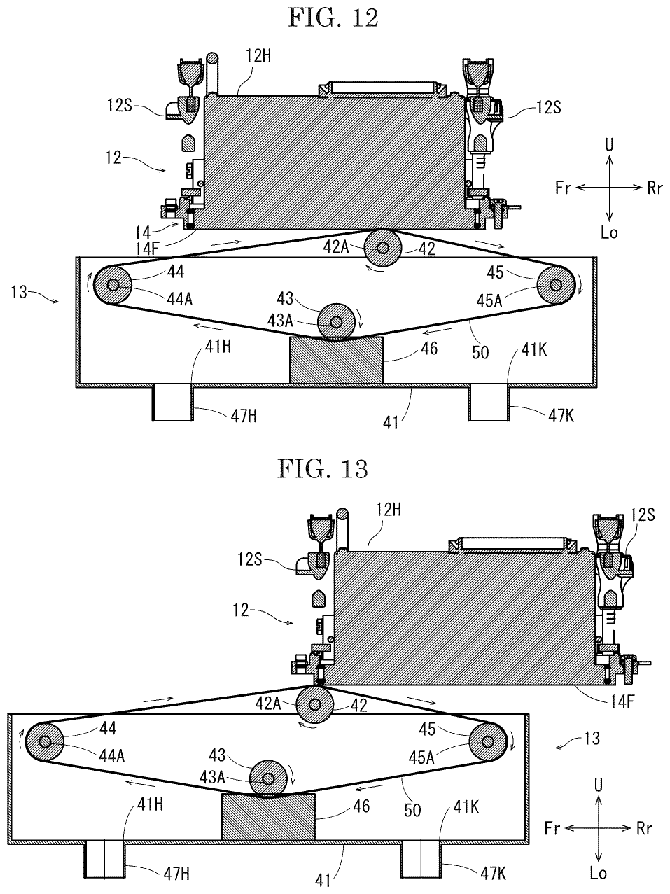

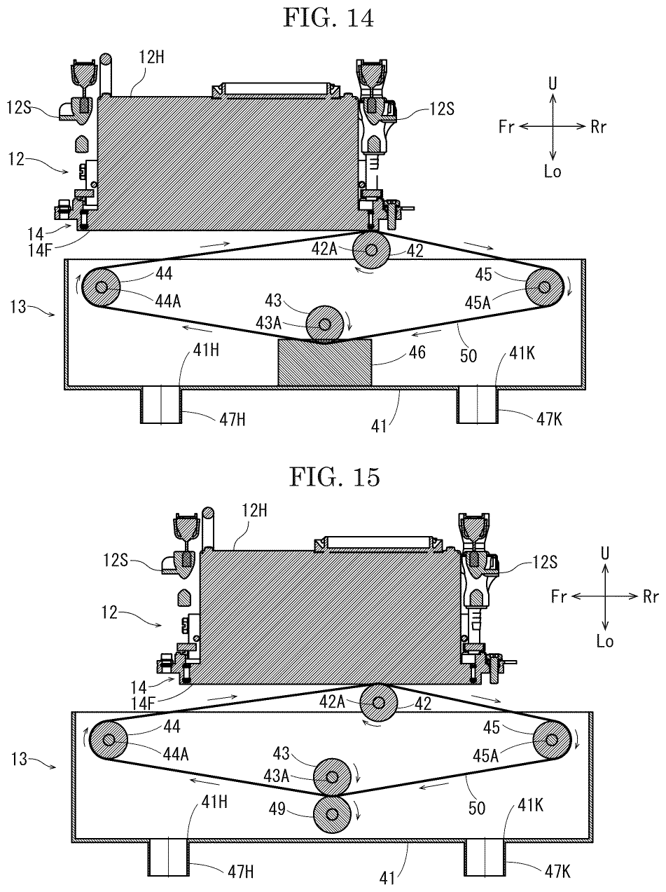

The basic image forming operation of the inkjet recording apparatus 1 is as follows. When an image forming job is input to the inkjet recording apparatus 1 from an external computer or the like, the control part 2 drives the feed roll 4, the conveying unit 7, and the rewind roll 9 in the counterclockwise direction in FIG. 2, and the sheet S is conveyed in the Y direction along the conveyance path 10. When the control part 2 supplies a drive signal corresponding to the image data to the driving circuit 12D in synchronization with the conveyance of the sheet S, the driving circuit 12D supplies an ejection signal corresponding to the gradation of the image data to the pressurizing element 14Z, and the ink is ejected from the nozzle 14N.

[Maintenance Device] The maintenance device 30 (see FIG. 3) includes a cap unit 31, a wipe unit 32, and a cleaning liquid supply unit 13. The maintenance device 30 is provided at the right end portion of the upper housing 3B. Although only one wipe unit 32 is shown in FIG. 3, actually, the same number of the wipe units 32 as the inkjet head 12 are arranged at the same interval as the inkjet head 12. Although only one cleaning liquid supply unit 13 is shown in FIG. 3, actually, the same number of the cleaning liquid supply units 13 as the inkjet head 12 are arranged at the same interval as the inkjet head 12.

[Wipe Unit] The wipe unit 32 includes a frame body 81 and a blade 82 provided on the upper surface of the frame body 81. The maintenance device 30 is provided with a sliding device 83 for sliding the wipe unit 32 in the front-and-rear direction (the longitudinal direction of the nozzle surface 14F).

[Cap Unit] The cap unit 31 includes a rectangular parallelepiped frame body 71. A portion of the frame body 71 corresponding to the upper surface of the rectangular parallelepiped is open. The frame body 71 is provided with the same number of caps 72 as the inkjet heads 12 in the same arrangement as the inkjet heads 12 in the image forming unit 6. The maintenance device 30 is provided with a lifting device 77 for lifting and lowering the cap unit 31. After the image forming unit 6 is moved above the cap unit 31, the cap unit 31 is lifted so that the cap 72 is attached on the nozzle surface 14F. The lifting device 77 may be provided in the image forming unit 6.

[Cleaning Liquid Supply Unit] FIG. 9 is a plan view showing the cleaning liquid supply unit 13 and the inkjet head 12. FIG. 10 is a right side view showing the cleaning liquid supply unit 13 and the inkjet head 12. FIG. 11 is a rear view showing the cleaning liquid supply unit 13 and the inkjet head 12. FIG. 12 to FIG. 14 are cross-sectional views showing the cleaning liquid supply unit 13 and the inkjet head 12.

The cleaning liquid supply unit 13 includes a rectangular parallelepiped frame body 41 whose longitudinal direction is along the front-and-rear direction. A portion of the frame body 41 corresponding to the upper surface of the rectangular parallelepiped is open. The frame body 41 is provided with a pressing roller 42, a counter roller 43, a driving roller 44 (an example of a driving part), a tension roller 45, and a cleaner 46. The pressing roller 42, the counter roller 43, the driving roller 44, and the tension roller 45 are supported by the frame body 41 via shafts 42A, 43A, 44A, and 45A whose axial directions are along the left-and-right direction, and are rotatable around the shafts 42A, 43A, 44A, and 45A, respectively. The cleaner 46 is provided at the center of the bottom of the frame body 41 in the front-and-rear direction. The cleaner 46 may be brush-like, sponge-like, or block-like with a rough surface.

A part or all of the pressing roller 42 is exposed upward from the upper edge portion of the frame body 41. The pressing roller 42 is disposed on the rear side of the cleaner 46. The driving roller 44 is disposed in front of the cleaner 46, and the tension roller 45 is disposed on the rear side of the pressing roller 42. The driving roller 44 and the tension roller 45 are disposed above the cleaner 46 and below the pressing roller 42.

A belt-like member 50 is an endless belt made of material having a liquid absorbency such as a nonwoven fabric, woven fabric, or porous resin. The belt-like member 50 is wound around the pressing roller 42, the tension roller 45, the counter roller 43, and the driving roller 44 in the order of in the clockwise direction. When the driving roller 44 is driven in the clockwise direction by a motor or the like (not shown), the belt-like member 50 circulates in the clockwise direction. The counter roller 43 is pressed against the cleaner 46, and the belt-like member 50 is held between the cleaner 46 and the counter roller 43.

The frame body 41 is provided with a replacement means for replacing the cleaning liquid. Specifically, a supply hole 41K and a discharge hole 41H are provided at the bottom of the frame body 41. A tank 13T for storing the cleaning liquid and a pump 13P for feeding the cleaning liquid are connected to the supply hole 41K via a supply pipe 47K. A pump 15P for sucking waste liquid and a tank 15T for storing the waste liquid are connected to the discharge hole 41H via a discharge pipe 47H. The cleaning liquid is supplied to the frame body 41 through the supply hole 41K. A liquid level of the cleaning liquid is controlled so that the lower portion of the counter roller 43 is immersed. The cleaning liquid is discharged through the discharge hole 41H at a predetermined timing, and replaced with the unused cleaning liquid. The predetermined timing may be, for example, after a predetermined amount of image forming is performed or may be periodic.

The cleaning liquid supply unit 13 is provided with a sliding device 48 for sliding the cleaning liquid supply unit 13 in the front-and-rear direction (the longitudinal direction of the nozzle surface 14F). As the sliding device 48, a belt drive, a feed screw, a rack and pinion, and the like are used. The sliding device 48 may be provided in the image forming unit 6.

[Operation of Maintenance Device] Next, the operation of the maintenance device 30 will be described. Maintenance of the inkjet head 12 is performed at a predetermined timing. The predetermined timing may be, for example, after one image forming job is completed, after a predetermined amount of image forming is performed, or periodically. Before the start of the maintenance, the cap unit 31 is retracted downward, and the cleaning liquid supply unit 13 and the wipe unit 32 are retracted rearward.

First, the control part 2 positions the image forming unit 6 so that all the inkjet heads 12 are positioned in front of the respective cleaning liquid supply units 13, and slides the frame body 41 by the sliding device 48 while circulating the belt-like member 50 in the clockwise direction (see FIG. 12 to FIG. 14). The cleaning liquid is supplied to the nozzle surface 14F by the belt-like member 50, the ink having a high viscosity remaining on the nozzle surface 14F is diluted by the cleaning liquid, and a waste liquid containing the ink and the cleaning liquid is wiped by the belt-like member 50. The belt-like member 50 holding the waste liquid is held between the counter roller 43 and the cleaner 46, and the waste liquid is removed from the belt-like member 50 by friction with the cleaner 46. Thus, since the belt-like member 50 can be repeatedly used in a near-unused condition, a frequency of replacement of the belt-like member 50 can be reduced.

Next, the control part 2 retracts the cleaning liquid supply unit 13 rearward, positions the image forming unit 6 so that all the inkjet heads 12 are positioned in front of the respective wipe units 32, and slides the wipe units 32 by a sliding device 83 to wipe the waste liquid containing the ink and the cleaning liquid from the nozzle surfaces 14F.

Next, the control part 2 retracts the wipe units 32 rearward, moves the image forming unit 6 above the cap units 31, lifts the cap units 31, and then waits until a new image forming job is inputted. Since the cap 72 is attached to the nozzle surface 14F, the nozzle surface 14F is moisturized and an increase in viscosity of the ink in the nozzle 14N is suppressed.

The maintenance device 30 according to the present embodiment described above includes the frame body 41 which stores the cleaning liquid; the pressing roller 42 which is exposed upward from the frame body 41 and pressed against the nozzle surface 14F of the inkjet head 12; the counter roller 43 which is provided below the pressing roller 42 and immersed in the cleaning liquid; the endless belt-like member 50 which is wound around the pressing roller 42 and the counter roller 43; and the driving part (the driving roller 44) which circulates the belt-like member 50. According to the present embodiment, when the cleaning liquid is supplied to the nozzle surface 14F using the belt-like member 50, a frequency of replacement of the belt-like member 50 can be reduced.

The maintenance device 30 according to the present embodiment includes the sliding device 48 which relatively slides the pressing roller 42 and the inkjet head 12 parallel to the nozzle surface 14F. According to the present embodiment, the cleaning liquid can be supplied over the entire nozzle surface 14F.

According to the maintenance device 30 according to the present embodiment, the replacement means (the pump 13P, the tank 13T, the pump 15P, the tank 15T, the discharge hole 41H, the supply hole 41K, the discharge pipe 47H, and the supply pipe 47K) which replaces the cleaning liquid is provided. According to the present embodiment, it is possible to use the cleaning liquid with little contamination by the waste liquid.

Further, according to the maintenance device 30 according to the present embodiment, the cleaner 46 which holds the belt-like member 50 with the counter roller 43 is provided. According to the present embodiment, the removal of dirt from the belt-like member 50 can be promoted.

According to the maintenance device 30 according to the present embodiment, the pressing roller 42 is disposed on the rear side of the counter roller 43 on the basis of a forward moving direction of the belt-like member 50 below the counter roller 43. The waste liquid is squeezed out from the belt-like member 50 pressed by the pressing roller 42 and falls, but if the pressing roller 42 is disposed in front of the counter roller 43 or directly above the counter roller 43, the belt-like member 50 from which the waste liquid is removed by the cleaner 46 is again contaminated with the waste liquid. According to the present embodiment, since the pressing roller 42 is disposed on the rear side of the counter roller 43, the waste liquid falling on the belt-like member 50 is removed by the cleaner 46. Therefore, according to the present embodiment, contamination of the belt-like member 50 can be suppressed.

The inkjet recording apparatus 1 according to the present embodiment includes the inkjet head 12 and the maintenance device 30. According to the present embodiment, since the ink ejection failure is suppressed, deterioration in image quality can be suppressed.

The above embodiments may be modified as follows.

FIG. 15 is a cross-sectional view showing a modified example. In this modified example, a roller-shaped cleaner 49 is provided instead of the cleaner 46 of the above embodiments. The counter roller 43 is pressed against the cleaner 49, and the belt-like member 50 is held between the cleaner 46 and the counter roller 43. The counter roller 43 is driven in the clockwise direction, and the cleaner 49 is driven in the clockwise direction by a motor or the like (not shown). The belt-like member 50 is rubbed by the cleaner 49 so that the waste liquid is removed.

In the above embodiment, the belt-like member 50 is wound around the pressing roller 42, the tension roller 45, the counter roller 43, and the driving roller 44, but the belt-like member 50 may be wound around at least a plurality of rollers including the pressing roller 42 and the counter roller 43. In this case, one of the plurality of rollers is driven.

In the above embodiment, the sliding device 48 slides the frame body 41 in the front-and-rear direction, but the sliding device 48 may be provided in the image forming unit 6. The sliding device 48 may be configured to slide the pressing roller 42 in the front-and-rear direction. In short, it may be configured such that the pressing roller 42 and the inkjet head 12 slide relatively parallel to the nozzle surface 14F.

1. A maintenance device comprising:
a frame body which stores a cleaning liquid;
a pressing roller which is exposed upward from the frame body and pressed against a nozzle surface of an inkjet head;
a counter roller which is provided below the pressing roller and immersed in the cleaning liquid;
an endless belt-like member which is wound around the pressing roller and the counter roller; and
a driving part which circulates the belt-like member.

2. The maintenance device according to claim 1, comprising:
a sliding device which relatively slides the pressure roller and the inkjet head parallel to the nozzle surface.

3. The maintenance device according to claim 1, comprising:
a replacement means which replaces the cleaning liquid.

4. The maintenance device according to claim 1, comprising:
a cleaner which holds the belt-like member between the counter roller and the cleaner.

5. The maintenance device according to claim 1, wherein
the pressing roller is disposed on a rear side of the counter roller on the basis of a forward moving direction of the belt-like member below the counter roller.

6. An inkjet recording apparatus comprising:
the inkjet head, and
the maintenance device according to claim 1.
